(19) United States
(12) Patent Application Publication
(10) Pub. No.: US 2025/0365268 A1
(43) Pub. Date: Nov. 27, 2025

(54) Methods and Devices for Supporting Authentication

(71) Applicant: Telefonaktiebolaget LM Ericsson (publ), Stockholm (SE)

(72) Inventors: Mukesh Thakur, Espoo (FI); Patrik Salmela, Espoo (FI); Mohit Sethi, Helsinki (FI)

(21) Appl. No.: 18/874,831

(22) PCT Filed: Jun. 16, 2022
(86) PCT No.: PCT/EP2022/066445

§ 371 Date: Dec. 13, 2024

(51) Int. Cl. H04L 9/40; H04L 9/32

(52) U.S. Cl. CPC H04L 63/0407; H04L 9/3247

(57) ABSTRACT

Methods and devices for supporting authentication of a first Transport Layer Security (TLS) device, wherein a second TLS device receives from the first TLS device a message indicative of the credential type that the first TLS devices will provide to be authenticated, i.e., Verifiable Credential (VC)-based certificate. The second TLS device then receives, from the first TLS device, a first VC and a first Verifiable Presentation (VP) proof which the second TLS device uses for authenticating the first TLS device.

### TECHNICAL FIELD

The invention relates to methods for supporting authentication of a first Transport Layer Security (TLS) device, a first TLS device for supporting authentication of the first TLS device, a second TLS device for supporting authentication of a first TLS device, and corresponding computer programs and computer program products.

### BACKGROUND

Transport Layer Security (TLS) is a cryptographic protocol that provides end-to-end security of data. The TLS protocol is used for example for securing web traffic and as an option for primary and secondary authentication in 5G via Extensible Authentication Protocol (EAP)-TLS. The TLS protocol consists of two layers, the TLS record protocol, and the TLS handshake protocol. The TLS handshake protocol allows a TLS client and a TLS server to negotiate a protocol version, encryption algorithm and cryptographic keys, and optionally authenticate each other before any data is transmitted. Once the TLS handshake is complete, the TLS client and the TLS server use the negotiated cryptographic keys to protect application-layer traffic. FIG. 1 shows a message flow for a full TLS handshake according to Internet Engineering Task Force (IETF) RFC 8446 (2018), wherein the symbol * (asterisk) indicates optional or situation-dependent messages/extensions that are not always sent. In case of authentication, a message comprising a digital certificate is sent by the TLS server and/or the TLS client. A certificate certifies the ownership of a public key by a named subject of the certificate, and indicates certain expected usages of the public key. Digital certificates are usually assigned by a trusted Certificate Authority.

X.509 is an International Telecommunication Union (ITU) standard defining the format of digital certificates and it is the de facto standard. However, there are efforts to specify the use of other certificate types and/or formats to reduce size of certificates or improve their flexibility. For example, Network Working Group Internet-Draft, S. Raza et al. “CBOR Encoded X.509 Certificates (C509 Certificates) draft-mattsson-cose-cbor-cert-compress-08” Feb. 22, 2021, discloses lightweight Concise Binary Object Representation (CBOR) encoded certificates for use with TLS.

### SUMMARY

It is an object of the invention to provide an improved alternative to the above techniques and prior art. More specifically, it is an object of the invention to provide improved authentication for Transport Layer Security (TLS) devices. This and other objects of the invention are achieved by means of different aspects of the invention, as defined by the independent claims. Embodiments of the invention are characterized by the dependent claims.

According to a first aspect of the invention, a method for supporting authentication of a first TLS device is provided. The method is performed by a second TLS device. The method comprises receiving a first credential type indication message from the first TLS device. The first credential type indication message is indicative of a credential type to use for authenticating the first TLS device. The credential type is Verifiable Credential (VC). The method further comprises receiving, from the first TLS device, a first VC, a first presentation metadata, and a first Verifiable Presentation (VP) proof for verifying the first TLS device. The method further comprises authenticating the first TLS device using the first VC, the first presentation metadata, and the first VP proof.

According to a second aspect of the invention, a method for supporting authentication of a first TLS device is provided. The method is performed by the first TLS device. The method comprises receiving a first VC from a trusted entity. The method further comprises sending a first credential type indication message to a second TLS device. The first credential type indication message comprises an indication of a credential type to use for authenticating the first TLS device. The credential type is VC. The method further comprises generating a first presentation metadata and a first VP proof. The method further comprises sending the first VC, the first presentation metadata, and the first VP proof to the second TLS device.

According to a third aspect of the invention, a second TLS device for supporting authentication of a first TLS device is provided. The second TLS device comprises a processing circuitry. The processing circuitry causes the second TLS device to be operative to receive a first credential type indication message from the first TLS device. The first credential type indication message comprises an indication of a credential type to use for authenticating the first TLS device. The credential type is VC. The second TLS device is further operative to receive, from the first TLS device, a first VC, a first presentation metadata, and a first VP proof for verifying the first TLS device. The second TLS device is further operative to authenticate the first TLS device using the first VC, the first presentation metadata, and the first VP proof.

According to a fourth aspect of the invention, a first TLS device for supporting authentication of the first TLS device is provided. The first TLS device comprises a processing circuitry. The processing circuitry causes the first TLS device to be operative to receive a first VC from a trusted entity. The first TLS device is further operative to send a first credential type request message to a second TLS device. The first credential type indication message comprises an indication of a credential type to use for authenticating the first TLS device. The credential type is a VC. The first TLS device is further operative to generate a first presentation metadata and a first VP proof. The first TLS device is further operative to send the first VC, the first presentation metadata, and the first VP proof to the second TLS device.

According to a fifth aspect of the invention, a computer program is provided. The computer program comprises instructions which, when run in a processing unit on a second TLS device, cause the second TLS device to carry out the method according to an embodiment of the first aspect of the invention.

According to a sixth aspect of the invention, a computer program product is provided. The computer program product comprises a computer readable storage medium on which a computer program according to the fifth aspect of the invention is stored.

According to a seventh aspect of the invention, a computer program is provided. The computer program comprises instructions which, when run in a processing unit on a first TLS device, cause the first TLS device to carry out the method according to an embodiment of the second aspect of the invention.

According to an eighth aspect of the invention, a computer program product is provided. The computer program product comprises a computer readable storage medium on which a computer program according to the seventh aspect of the invention is stored.

Certain embodiments may provide one or more of the following technical advantages. The solution disclosed herein makes it possible to integrate VC with TLS to provide a more flexible approach for adding additional information compared to state-of-the-art digital certificates, such as X.509. Instead of defining extensions for the additional information as done for example for X.509 certificates, an issuer of a VC for a holder may add to the VC any information that may be useful for taking a decision during the authentication of the holder. Moreover, the solution disclosed herein does not modify the TLS protocol exchange. Thus, systems using TLS could also support VC as credential type. VC could be used also in 5G.

Further objectives of, features of, and advantages with, the invention will become apparent when studying the following detailed disclosure, the drawings, and the appended claims. Those skilled in the art realize that different features of the invention can be combined to create embodiments other than those described in the following.

### BRIEF DESCRIPTION OF THE DRAWINGS

For better understanding of the present disclosure, and to show more readily how the invention may be carried into effect, reference will now be made, by way of example, to the following drawings, in which:

FIG. 1 shows a known messages exchanged between a Transport Layer Security (TLS) client and a TLS server in a full TLS handshake protocol;

FIG. 2a shows a known Verifiable Credentials (VCs) ecosystem;

FIG. 2b shows a known VC structure;

FIG. 2c shows a known Verifiable Presentation (VP) structure;

FIG. 3a shows messages exchanged between a first TLS device and a second TLS device according to embodiments of the invention;

FIG. 3b shows messages exchanged between a first TLS device and a second TLS device according to embodiments of the invention;

FIG. 4 shows messages exchanged between a TLS client and a TLS server if the TLS server is authenticated using as credential type VC according to embodiments of the invention;

FIG. 5a shows messages exchanged between a TLS client and a TLS server if the TLS client is authenticated using as credential type VC and the TLS server is authenticated using as credential type X.509 according to embodiments of the invention;

FIG. 5b shows messages exchanged between a TLS client and a TLS server if the TLS client is authenticated using as credential type VC and the TLS server is authenticated using as credential type X.509 according to embodiments of the invention;

FIG. 5c shows messages exchanged between a TLS client and a TLS server if the TLS client is authenticated using as credential type VC and the TLS server is authenticated using as credential type VC according to embodiments of the invention;

FIG. 5d shows messages exchanged between a TLS client and a TLS server if the TLS client is authenticated using as credential type X.509 and the TLS server is authenticated using as credential type VC according to embodiments of the invention;

FIG. 6a shows a flowchart illustrating a method performed by a second TLS device according to embodiments of the invention;

FIG. 6b shows a flowchart illustrating a method performed by a first TLS device according to embodiments of the invention;

FIG. 7 is a block diagram depicting a second TLS device according to embodiments of the invention;

FIG. 8 is a block diagram depicting units of a second TLS device according to embodiments of the invention;

FIG. 9 is a block diagram depicting a first TLS device according to embodiments of the invention; and

FIG. 10 is a block diagram depicting units of a first TLS device according to embodiments of the invention.

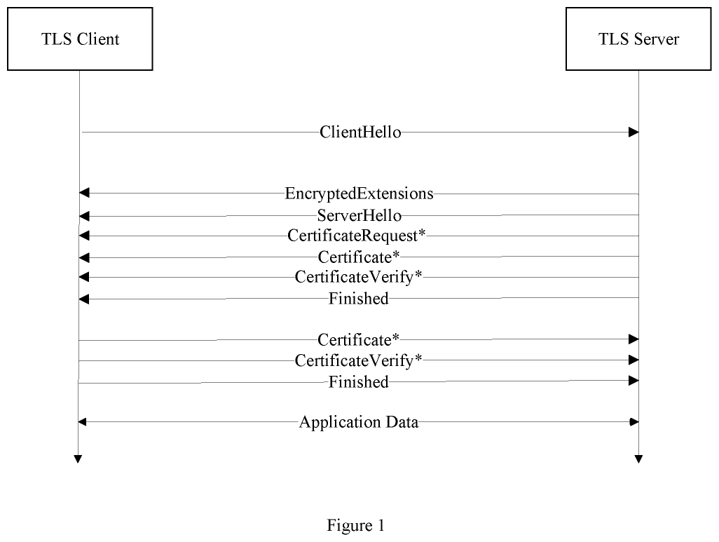

### DETAILED DESCRIPTION

Embodiments will be illustrated herein with reference to the accompanying drawings. These embodiments are provided by way of example so that this disclosure will be thorough and complete, and will fully convey the scope of the inventive concept to those skilled in the art.

X.509 certificates are the de facto standard for digital certificates for Transport Layer Security (TLS). A X.509 certificate has a fixed set of attributes and extensions for adding specific additional information to the certificate, such as alternative subject names and usage restrictions to the certificate. The additional information allows better decision-making during authentication. If X.509 certificate is used, an entity verifying the certificate needs to know and understand the extensions to be able to parse the additional information in the extension.

The solution disclosed herein makes it possible to integrate Verifiable Credentials (VC) with TLS to provide a more flexible approach for adding additional information compared to state-of-the-art digital certificates, such as X.509. VCs are a standard way of defining credentials on the Web which is cryptographically secure, privacy respecting and machine-verifiable. Instead of defining extensions for the additional information as done for X.509 certificates, an issuer of a VC for a holder may add to the VC any information that may be useful for taking a decision during the authentication of the holder.

Embodiments of the invention described herein are based on such an integration of VC with TLS. More specifically, a second TLS device may receive from a first TLS device a message indicative of a credential type that the first TLS devices will provide to be authenticated, i.e., VC. The second device receives, from the first TLS device, a first VC, a first presentation metadata, and a first Verifiable Presentation (VP) proof which the second TLS device uses for authenticating the first TLS device. The first VC, the first presentation metadata, and the first VP proof may be comprised in a first VP. One or both the TLS devices may use VC, presentation metadata, and VP proof to be authenticated. If both TLS devices require authentication, only one TLS device may use VC, presentation metadata, and VP proof and the other TLS device may use a different credential type. The credential type indicates credentials and/or certificates for authentication. The credential type comprises VC and digital certificates. Examples of VC comprise digital employee identification cards, digital birth certificates, and digital educational certificates. Examples of certificates comprise X.509, OpenPrettyGoodPrivacy (OpenPGP), Raw Public Key, or 1609Dot2.

The disclosed solution integrates the use of VC with TLS without modifying the TLS handshake protocol, which is therefore backward compatible with systems currently using TLS.

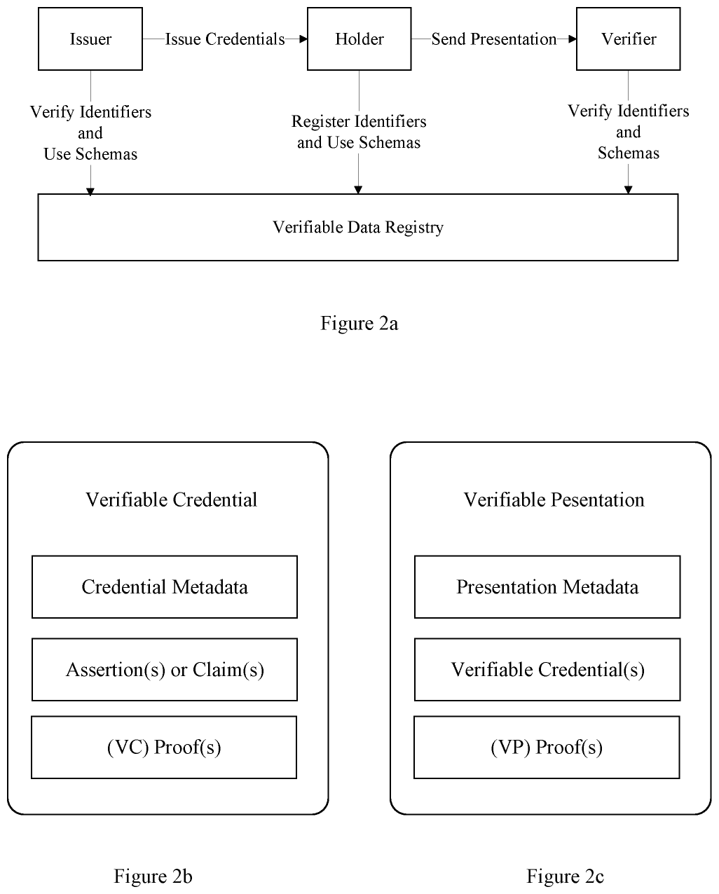

FIG. 2a shows a VC ecosystem comprising an issuer, a holder, a verifier, and a verifiable data registry. The issuer represents a role of an entity, e.g., a trusted authority, which creates a VC based on one or more assertions (also known as claims) and transmits the VC to the holder. The holder represents a role of an entity, e.g., the first TLS device, which possesses one or more VCs and generates VPs based on the one or more possessed VCs. The verifier represents a role of an entity, e.g., the second TLS device, which verifies the one or more VPs. The issuer, the holder, and the verifier, cryptographically create a Decentralized Identifier (DID), i.e., a type of globally unique and persistent identifier, and associate a set of public keys to their DID.

The verifiable data registry maintains DIDs and schemas, i.e., templates which are used to verify structure and contents of VCs. The verifiable data registry could be a trusted database, decentralized database, government identifier database, blockchain, or some other secure and accessible service. Further information on the VC ecosystem can be found in “Verifiable Credentials Data Model v1.1”, W3C Recommendation, W3C, 3 Mar. 2022, https://www.w3.org/TR/2022/REC-vc-data-model-20220303/.

FIG. 2b shows an example VC structure. A VC comprises credential metadata, one or more tamper-evident assertions, also known as claims, and (VC) proof(s). Credential metadata is data describing properties of the one or more assertions, and may include one or more of: issuer information, expiry date and time of the one or more assertions, a representative image, and indication of a revocation mechanism. The assertions are statements made about a subject. The subject is usually the holder, and an example of an assertion is a public key, name, age, organization of the holder. (VC) proof(s) is information about the identity of the issuer that allows other entities to verify the source of the VC (i.e., the issuer), check that the VC belongs to the holder, the VC has not been tampered with, and the VC has not been revoked by the issuer. In the present disclosure, VC indicates a type of credential and a data structure comprising the credential metadata, the one or more assertions, and the (VC) proof(s).

The holder may create a VP. An example VP structure is shown is FIG. 2c. A VP comprises presentation metadata, one or more VCs, and (VP) proof(s). The presentation metadata provides information about the VP such as type of data and instructions on whether the VP can be archived. The (VP) proof(s) is a digital signature of the holder that allows other entities to verify the holder.

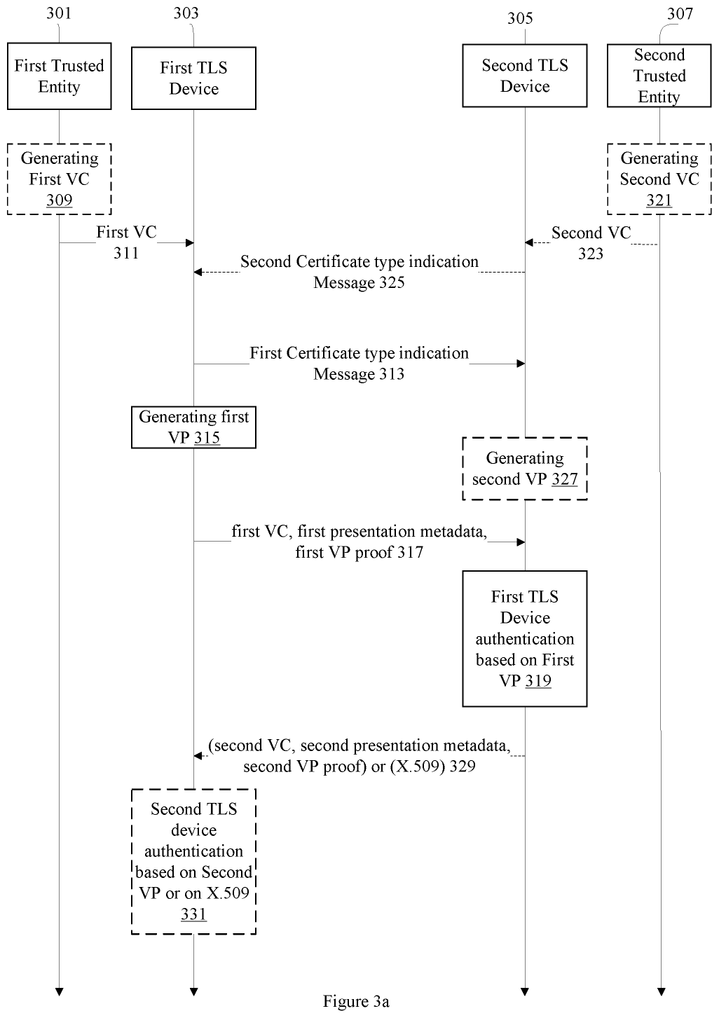

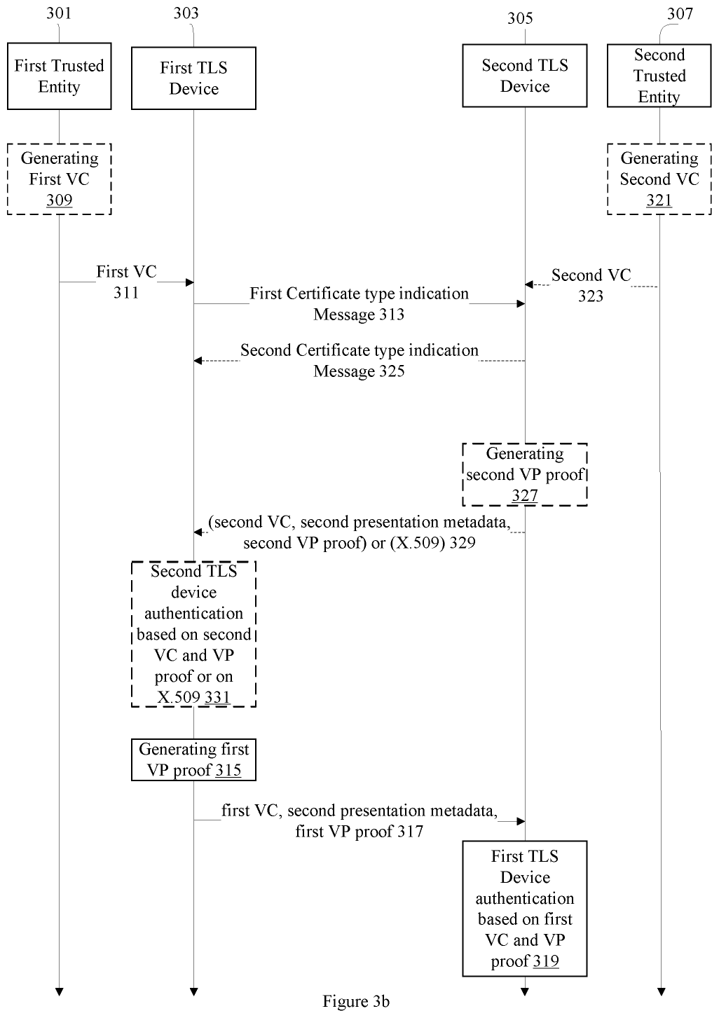

FIG. 3a shows an exchange of messages between a first trusted entity 301, a first TLS device 303, a second TLS device 305, and a second trusted entity 307, according to an embodiment of the invention. FIG. 3b shows an exchange of messages between the first trusted entity 301, the first TLS device 303, the second TLS device 305, and the second trusted entity 307, according to an alternative embodiment of the invention.

As shown in FIG. 3a, the first trusted entity 301 is the issuer of a first VC that is to be used by the first TLS device 303 to create a first VP. The first VP comprises the first VC, a first presentation metadata, and a first VP proof. The second trusted entity 307 is the issuer of a second VC that may be used by the second TLS device 305 to create a second VP if the second TLS device 305 supports VC as a type of credential for being authenticated. The second VP comprises the second VC, a second presentation metadata, and a second VP proof. The first trusted entity 301 and the second trusted entity 307 may be the same entity.

Specifically, the first trusted entity 301 generates 309 and sends 311 the first VC to the first TLS device 303. The first VC comprises one or more assertions on the first TLS device, a first credential metadata, and a first VC proof for verifying the trusted entity which issued the first VC, i.e., the first trusted entity 301.

If also the second TLS device 305 supports VC to be authenticated, the second trusted entity 307 generates 321 and sends 323 a second VC to the second TLS device 305. The second VC comprises one or more assertions on the second TLS device 305, a second credential metadata, and a second VC proof for verifying the trusted entity which issued the second VC, i.e., the second trusted entity 307. The generation of the first VC 309 and the generation of the second VC 323 are typically performed once. They may be performed before the first TLS device and the second TLS device start the TLS handshake.

In order to be authenticated using VC as credential type, the first TLS device 303 indicates to the second TLS device 305 the credential type it supports to be authenticated, i.e., VC, by transmitting 313 a first credential type indication message. The first TLS device 303 generates 315 a first VP, wherein the first VP comprises a first presentation metadata, the received first VC, and a first VP proof. The first VP proof is a signature over messages exchanged between the first TLS device 303 and the second TLS device 305 in the TLS handshake. The signature is generated further based on a message comprising the first VC and the presentation metadata if the first VC and the first presentation metadata are sent in a message and the first VP proof is sent in a separate message, or the signature is generated further based on the first VC and the first presentation metadata if the first VC, the first presentation metadata, and the first VP proof are sent in a same message. For example, considering only the non-optional messages in FIG. 3a, the signature is based on the first credential type indication message, the first VC, and the first presentation metadata. If further messages have been exchanged between the first TLS device 303 and the second TLS device 305, the signature is calculated further based on the further messages. For example, considering also the non-optional messages in FIG. 3, the signature is based on
the first credential type indication message,
a second credential type indication message,
a second VC, a second presentation metadata, and a second VP proof, or X.509, and
the first VC, and the first presentation metadata.

Therefore, the first VP proof is not used only for verifying the first VC, but for verifying the messages sent between the first TLS device 303 and the second TLS device 305. The signature may be determined using an algorithm according to RFC 8446. After generating 315 the first VP, the first TLS device 303 transmits 317 to the second TLS device 305 the first VC, the first presentation metadata, and the first VP proof. The first VC, the first presentation metadata, and the first VP proof may be sent in a same message, or the first VC and the first presentation metadata may be sent in a message, and the VP proof in a separate message. The second TLS device 305 uses the received first VC, first presentation metadata, and first VP proof to authenticate 319 the first TLS device 303.

If also the second TLS device 305 requires to be authenticated, the second TLS device 305 may indicate to the first TLS device 305 the credential type it supports for being authenticated by transmitting 325 a second credential type indication message. The type of credential may be VC, X.509, or any other type of credential supported, such as OpenPGP, Raw Public Key, or 1609Dot2. The second credential type indication message may be sent by the second TLS device before the first TLS device 303 sends 313 the first credential type indication message, according to an embodiment of the invention, as shown in FIG. 3a. In particular, this embodiment may be implemented if the first TLS device 303 is a TLS server and the second TLS device 305 is a TLS client. Alternatively, the second credential type indication message may be sent by the second TLS device after the first TLS device 303 sends 313 the first credential type indication message, as shown in FIG. 3b. In particular, this embodiment may be implemented if the first TLS device 303 is a TLS client and the second TLS device 305 is a TLS server.

If the type of certificate supported by the second TLS device 305 is VC, the second TLS device 305 receives 323 from the second trusted authority 307 the second VC and generates 327 a second VP. The second VP comprises the received second VC, a second presentation metadata, and a second VP proof. The second VP proof comprises a signature over messages exchanged between the first TLS device 303 and the second TLS device 305 in the TLS handshake. For example, if the first VC, the first presentation metadata and the first VP proof are transmitted after the second VC, the second presentation metadata, and the second VP proof as shown in FIG. 3a, the signature comprised in the second VP proof is determined based on the first credential type indication message, the second credential type indication message, the second VC, the second presentation metadata, and the second VP proof.

The second TLS device 305 transmits 329 the second VC, the second presentation metadata, and the second VP proof to the first TLS device 303. The first TLS device 303 uses the received second VC, second presentation metadata, and second VP proof to authenticate 331 the second TLS device 305.

If the only supported credential type by the second TLS device is X.509, according to an embodiment, the second TLS device 305 does not send a second credential type indication message because X.509 is considered a default credential type to use. The second TLS device 305 transmits 329 the X.509 certificate to the first TLS device 303 and the first TLS device 303 uses the received X.509 certificate to authenticate 331 the second TLS device 305. In particular, this embodiment may be implemented if the first TLS device 303 is a TLS server and the second TLS device 305 is a TLS client, or if the first TLS device 303 is a TLS client and the second TLS device 305 is a TLS server and the TLS client does not send a message to the TLS server with an indication of the credential types that the TLS client supports for authenticating the TLS server.

According to an alternative embodiment, the first TLS device 303 may send a message to the second TLS device 305 with an indication of the credential types that the first TLS device 303 supports for authenticating the second TLS device 305, e.g., VC, X.509, OpenPGP, Raw Public Key, or 1609Dot2. In this case, the second TLS device 305 may respond by transmitting the second credential type indication message to indicate that a X.509 credential type will be provided. In particular, this embodiment may be implemented if the first TLS device 303 is a TLS client and the second TLS device 305 is a TLS server. The second TLS device 305 transmits 329 the X.509 certificate to the first TLS device 303 and the first TLS device 303 uses the received X.509 certificate to authenticate 331 the second TLS device 305.

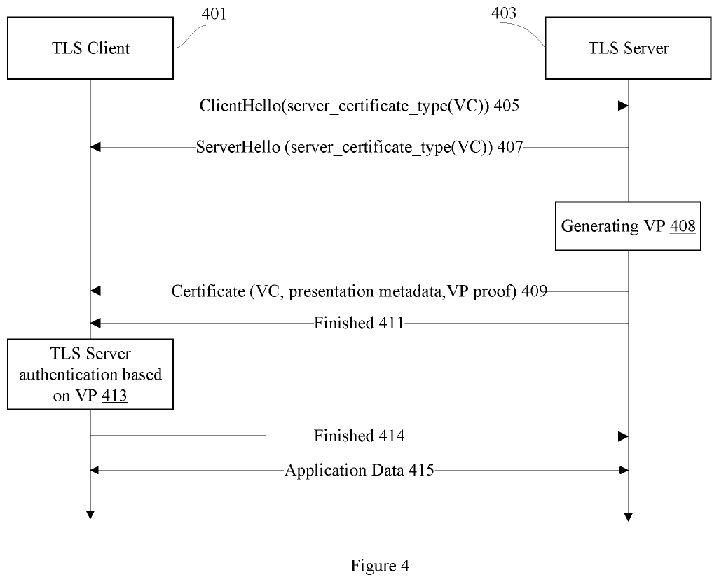

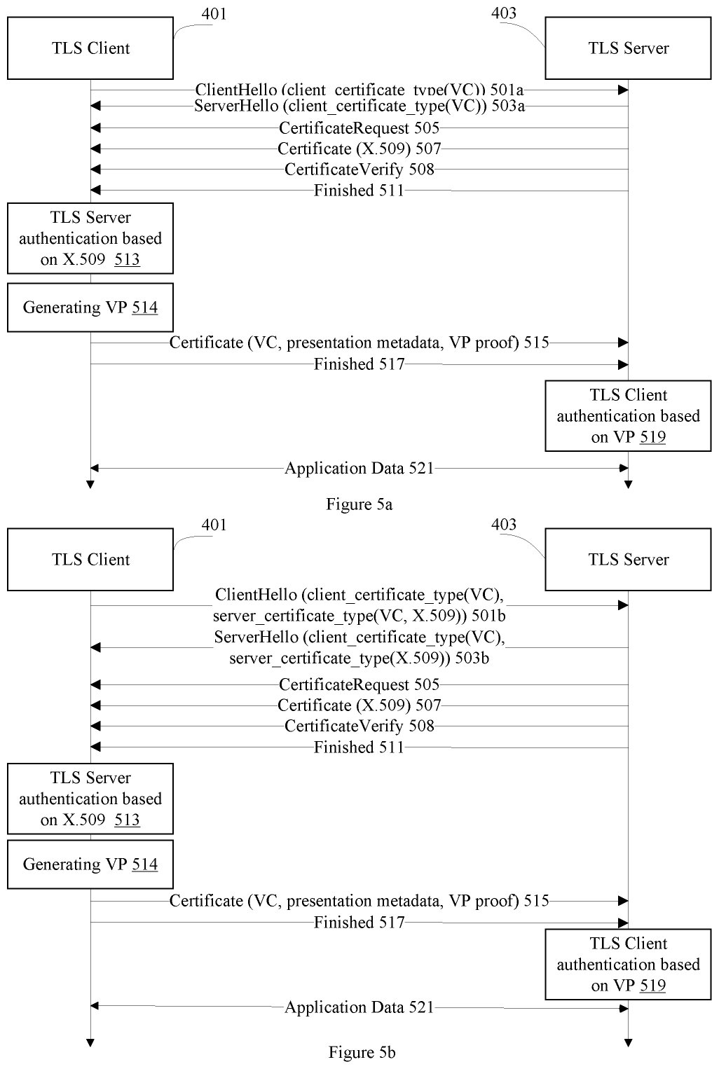

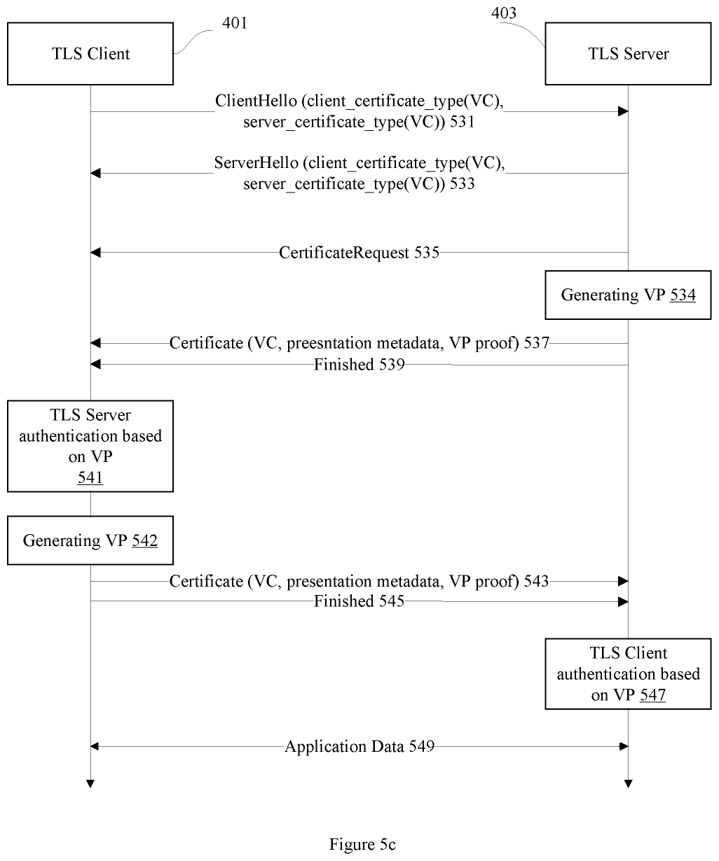

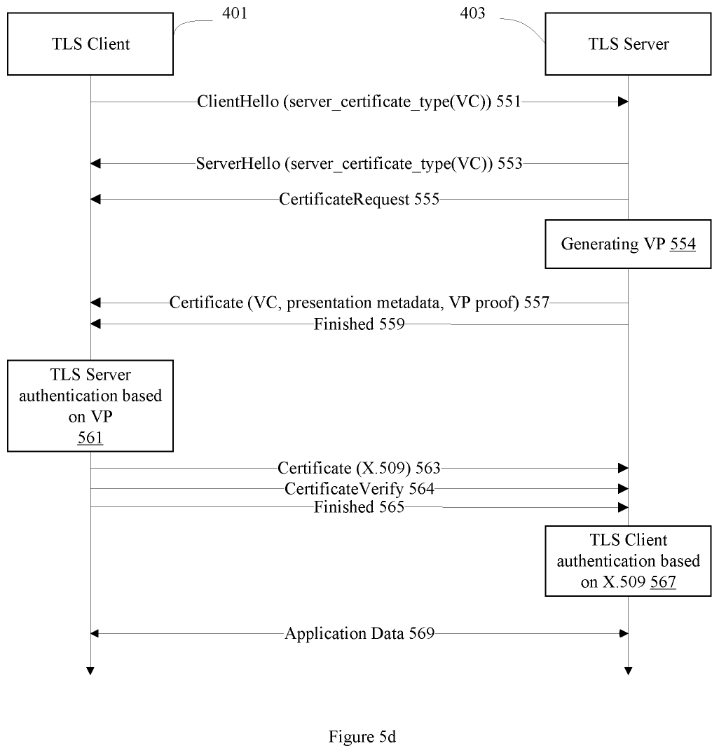

The first TLS device may be one of a TLS client and a TLS server, and the second TLS device may be the other one of the TLS client and the TLS server. In the known TLS handshake protocol, the authentication of the TLS client is optional. FIGS. 4 and 5a-d show messages exchanged between a TLS client and a TLS server in a TLS handshake protocol according to embodiments the invention. Note that not all messages of the TLS handshake protocol according to RFC 8446 have been shown in FIGS. 4 and 5a-d, but only the messages relevant for authenticating the TLS client and/or the TLS server.

FIGS. 4 show messages exchanged between a TLS client 401 and a TLS server 403 for a scenario in which only the TLS server 403 requires to be authenticated and the TLS server 403 indicates to the TLS client 401 to use VC as credential type for authentication. The first TLS device 303 corresponds to the TLS server 403 and the second TLS device 305 corresponds to the TLS client 401 of FIGS. 3a and 3b.

Specifically, the TLS client 401 begins the TLS handshake by sending 405 a “ClientHello” message and the TLS server 403 responds by sending 407 a “ServerHello” message. The TLS client 401 may indicate in the “ClientHello” message the types of certificates supported to authenticate the TLS server 403. The “ClientHello” message may comprise a “server certificate_type” extension field carrying a list of supported credential types to authenticate the TLS server 403. If the TLS client 401 supports only one credential type, e.g., VC, the list contains a single element. The “ServerHello” message may comprise a “server_certificate_type” extension field carrying the selected credential type, i.e., VC. The “ServerHello” message comprising the “server_certificate_type” extension field carrying VC corresponds to the first credential type indication message 313 of FIGS. 3a and 3b if the first TLS device 303 is the TLS server 403 and the second TLS device 305 is the TLS client 401. More details on “server_certificate_type” extension field in the “ClientHello” and “ServerHello” message can be found in (IETF) RFC 7250 (2014) and the same considerations apply to “ClientHello” and “ServerHello” message of FIGS. 5a-d.

Then, the TLS server 403 generates 408 a VP, wherein the VP comprises a VC, a presentation metadata, and a VP proof. The VC has been received by the TLS server 403 from a trusted authority (not shown in FIG. 4) and the VP proof has been generated by the TLS server 403 based on messages exchanged between the TLS server 403 and the TLS client 401 in the TLS handshake.

The TLS server 403 transmits 409 the VC, the presentation metadata, and the VP proof to the TLS client 401. The VC, the presentation metadata, and the VP proof may be sent in a single message (as shown in FIG. 4) or in two separate messages (not shown in FIG. 4). For example, the VC and the presentation metadata may be sent in a “Certificate” message and the VP proof may be sent in a “CertificateVerify” message of the TLS handshake protocol according to RFC 8446. The step of transmitting 409 the VC, the presentation metadata, and the VP proof of FIG. 4 corresponds to the step of sending the first VC, first presentation metadata, and the first VP proof of FIGS. 3a and 3b if the first TLS device 303 is the TLS server 403 and the second TLS device 305 is the TLS client 401.

The TLS server 403 transmits 411 a “Finished” message to the TLS client 401 indicating that the TLS server part of the handshake is complete. The TLS client 401 uses the received VC and VP proof to authenticate 413 the TLS server 403.

Then, the TLS client 401 sends 414 a “Finished” message to the TLS server 403 indicating that the TLS client part of the handshake is complete and the TLS client 401 the TLS server 403 may start exchanging 415 application data.

FIGS. 5a-d show messages exchanged between a TLS client 401 and a TLS server 403 in case of mutual authentication, i.e., if both the TLS client 401 and the TLS server 403 require authentication.

In particular, FIGS. 5a and 5b shows message exchanged between the TLS client 401 and the TLS server 403 if the TLS client 401 is authenticated by using VC as credential type and the TLS server 403 is authenticated with X.509. FIG. 5a shows the case wherein the TLS server 403 does not send a credential type indication message, i.e., a “server_certificate_type” extension field in a “ClientHello” message, since X.509 is a default credential type and the TLS client does not provide further supported credential types. FIG. 5b shows the case wherein the TLS client provides VC and X.509 as supported credential types to authenticate the TLS server and the TLS server indicates X.509 as credential type to use to be authenticated. The TLS client 401 may indicate any other supported credential type to authenticate the TLS server 403, such as OpenPGP, Raw Public Key, or 1609Dot2.

As shown in FIG. 5a, the TLS client 401 sends 501a a message to the TLS server 403 indicating that it supports VC as credential type for authentication. The indication may, for example, be comprised in the “client_certificate_type” extension field of the “ClientHello” message. The TLS server 403 will reply 503a with a “ServerHello” message. The TLS server 403 confirms that it will use VC as credential type for the authentication of the TLS client 401 by indicating VC as credential type in the “client_certificate_type” extension field of the “ServerHello” message. More details on “client_certificate_type” extension field in the “ClientHello” and “ServerHello” message can be found in RFC 7250 and the same considerations apply to “ClientHello” and “ServerHello” message of FIGS. 5b-d. The indication sent in the “ClientHello” message corresponds to the “first credential type indication message” of FIG. 3b if the first TLS device is the TLS client and the second TLS device is the TLS server.

Then the TLS server 403 sends 505 a “CertificateRequest” message to request a certificate from the TLS client 401 and the TLS server transmits 507 its X.509 in a “Certificate” message and authentication data in a “CertificateVerify” message 508. The transmission of the X.509 and of the authentication data corresponds to the transmission of X.509 329 in FIG. 3b if the first TLS device is the TLS client and the second TLS device is the TLS server.

The TLS server 403 transmits 511 a “Finished” message to the TLS client 401 indicating that the TLS server part of the handshake is complete.

The TLS client 401 generates 514 a VP, wherein the VP comprises a VC, a presentation metadata, a VP proof. The TLS client 401 transmits 515 the VC, the presentation metadata, and the VP proof to the TLS server 403, wherein the VC has been received by the TLS client 401 from a trusted authority (not shown in FIG. 5a) and the VP proof has been generated by the TLS client 401 based on messages exchanged between the TLS client 401 and the TLS server 401 in the TLS handshake. The VC, the presentation metadata, and the VP proof may be sent in a single message or in two separate messages. For example, the VC and the presentation metadata may be sent in the “Certificate” message and the VP proof may be sent in the “Certificate Verify” message of the TLS handshake protocol according to RFC 8446. The step of transmitting 515 the VC, the presentation metadata, and the VP proof of FIG. 5a corresponds to the step 317 of sending the first VC, first presentation metadata, and first VP proof of FIG. 3b if the first TLS device is the TLS client and the second TLS device is the TLS server.

The TLS client 401 sends 517 a “Finished” message to the TLS server 403 indicating that the TLS client part of the handshake is complete.

The TLS client 401 authenticates 513 the TLS server 403 using the received X.509 certificate and authentication data and the TLS server 403 authenticates 519 the TLS client 401 using the received VC, presentation metadata, and VP proof. Then, the TLS client 401 and the TLS server 403 may start exchanging 521 application data.

FIG. 5b shows an embodiment of the invention, wherein the TLS client 401 indicates 501b two supported credential types, i.e., VC and X.509, to use for authenticating the TLS server 403, and the TLS server 403 indicates 503b X.509 as credential type to use to be authenticated.

Differently from FIG. 5a, the “ClientHello” message sent from the TLS client 401 to the TLS server 403, comprises besides the “client_certificate_type” extension field, also the “server_certificate_type” extension field indicating the two supported credential types by the TLS client to authenticate the TLS server, i.e., VC and X.509, and the “ServerHello” message sent from the TLS server 403 to the TLS client 401, comprises besides the “client_certificate_type”, also the “server_certificate_type” extension field indicating the credential type provided by the TLS server to be authenticated by the TLS client, i.e., X.509, selected between the credential types provided by the TLS client. The indication of the supported certificate that the TLS server 403 will provide to be authenticated sent in the “ServerHello” message corresponds to the “second credential type indication message” 325 of FIG. 3b if the first TLS device is the TLS client and the second TLS device is the TLS server.

FIG. 5c shows message exchanged between a TLS client 401 and a TLS server 403 if both the TLS client 401 and the TLS server 403 support and provide VC as credential type to be authenticated. First, the TLS client 401 sends 531 a message to the TLS server 403 indicating that it will provide a VC as credential type. The indication may, for example, be comprised in the “client_certificate_type” extension field of a “ClientHello” message. The indication sent in the “ClientHello” message corresponds to the “first credential type indication message” 313 of FIG. 3b if the first TLS device is the TLS client and the second TLS device is the TLS server.

The TLS client 401 also indicates that it will authenticate the TLS server 403 using VC as credential type. The indication may for example be comprised in a “server_certificate_type” extension field of the “ClientHello”. The TLS server 403 replies 533 with a “ServerHello” message and an indication that it will also provide a certificate of type VC. The indication may be comprised in the “server_certificate_type” extension field of the “ServerHello” message.

The indication sent in the “ServerHello” message corresponds to the “second credential type indication message” of FIG. 3b if the first TLS device is the TLS client and the second TLS device is the TLS server. The TLS server 403 will also confirm that it will use VC as credential type for the authentication of the TLS client 401 in the “client certificate_type” extension field of the “ServerHello” message.

The TLS server 403 requests a certificate from the TLS client 401 by transmitting 535 a “CertificateRequest” message; generates 534 a VP, wherein the VP comprises a VC, a presentation metadata, and a VP proof. The VC has been received by the TLS server 403 from a trusted authority (not shown in FIG. 5c) and the VP proof has been generated by the TLS server 403 based on the data exchanged between the TLS client 401 and the TLS server 403. The TLS server 403 sends its certificate by transmitting 537 the VC, the presentation metadata, and the VP proof to the TLS client 401 that correspond to the second VC, second presentation metadata, and second VP proof 329 of FIG. 3b if the first TLS device is the TLS client and the second TLS device is the TLS server. The VC, the presentation metadata, and the VP proof may be sent in a single message or in two separate messages. For example, the VC and the presentation metadata may be sent in the “Certificate” message and the VP proof may be sent in the “CertificateVerify” message of the TLS handshake protocol according to RFC 8446. Then, the TLS server 403 sends 539 a “Finished” message to the TLS client 401 indicating that the TLS server part of the handshake is complete.

The TLS client 401 generates 542 a VP, wherein the VP comprises a VC, a presentation metadata, a VP proof. The VC has been received by the TLS client 401 from a trusted authority (not shown in FIG. 5c) and the VP proof has been generated by the TLS client 401 based on the data exchanged between the TLS client 401 and the TLS server 403. The TLS client 401 transmits 543 to the TLS server 403 its VC, presentation metadata, and VP proof that correspond to the first VC, first presentation metadata, and first VP proof 317 of FIG. 3b if the first TLS device is the TLS client and the second TLS device is the TLS server. The VC, the presentation metadata, and the VP proof may be sent in a single message or in two separate messages. For example, the VC and presentation metadata may be sent in the “Certificate” message and the VP proof may be sent in the “CertificateVerify” message of the TLS handshake protocol according to RFC 8446. Then, the TLS client 401 sends 545 a “Finished” message to the TLS server 403 indicating that the TLS client part of the handshake is complete.

The TLS client 401 authenticates 541 the TLS server 403 using the received VC, presentation metadata and VP proof, and the TLS server 403 authenticates 547 the TLS client 401 using the received VC, presentation metadata, and VP proof. Then, the TLS client 401 and the TLS server 403 may start exchanging 549 application data.

FIG. 5d shows messages exchanged between a TLS client 401 and a TLS server 403 if the TLS client 401 provides a X.509 certificate to be authenticated and the TLS server 403 provides a certificate of type VC to be authenticated.

The TLS client 401 sends 551 a message to the TLS server 403 indicating that it supports VC to authenticate the TLS server 403. The indication may, for example, be comprised in the “server_certificate_type” extension field of a “ClientHello” message. The TLS server 403 replies 553 with a “ServerHello” message and an indication that it will provide a certificate of type VC. The indication may be comprised in the “server_certificate_type” extension field of the “ServerHello” message. The indication sent in the “ServerHello” message corresponds to the “first credential type indication message” 313 of FIG. 3a if the first TLS device is the TLS server and the second TLS device is the TLS client.

The TLS client 401 may not send a second credential type indication message because X.509 is considered a default credential type to use. Alternatively, the TLS client 401 may send a credential type indication message comprising X.509 and one or more further supported credential types, such as VC, OpenPGP, Raw Public Key, or 1609Dot2. The TLS server 403 may respond indicating X.509 as the credential type to use (not shown in FIG. 5d).

The TLS server 403 transmits 555 a “CertificateRequest” message to the TLS client 401, wherein the TLS server 403 requests a certificate from the TLS client 401; and generates 554 a VP, wherein the VP comprises a VC, a presentation metadata and a VP proof, and the VC has been received by the TLS server 403 from a trusted authority (not shown in FIG. 5d) and the VP proof has been generated by the TLS server 403 based on the data exchanged between the TLS client 401 and the TLS server 403. The TLS server 403 transmits 557 the VC, the presentation metadata, and the VP proof. The VC, the presentation metadata, and the VP proof may be sent in a single message or in two separate messages. For example, the VC and the presentation metadata may be sent in the “Certificate” message and the VP proof may be sent in the “Certificate Verify” message of the TLS handshake protocol according to RFC 8446. The TLS server 403 transmits 559 a “Finished” message to the TLS client 401 indicating that the TLS server part of the handshake is complete.

The TLS client 401 transmits 563, 564 its X.509 in a “certificate” message, authentication data in a “certificateverify” message, and a “Finished” message 565 indicating that the TLS client part of the handshake is complete.

The TLS client 401 uses the received VC, presentation metadata, and VP proof to authenticate 561 the TLS server 403. The TLS server 403 authenticates 567 the TLS client 401 using the received X.509 certificate and authentication data. Then, the TLS client 401 and the TLS server 403 may start exchanging 569 application data.

Once a first TLS device, i.e., the TLS client or the TLS server, has received a VC, a presentation metadata, and a VP proof from a second TLS device, the first TLS device parses the received VC, presentation metadata, and VP proof and processes them to authenticate the second TLS device.

More specifically, the first TLS device fetches from the verifiable data registry a schema of the VC to interpret the data in the VC. The VC comprises at least
assertions of the holder (i.e., the second device), such as the holder public key or hash of the public key;
VC proof(s), i.e., signature type, timestamp of signature creation, purpose of the proof, issuer public key or public key hash or decentralized identifier or URL to public key; and
a digital signature of the issuer of the VC.

The first TLS device validates the digital signature of the issuer of the VC using the issuer public key. For example, the validation may be performed by calculating a hash of the VC, decrypting the digital signature using the issuer public key, and comparing the two hash values. Moreover, the information about the issuer identity/public key contained in the VC may be used for verifying if the issuer can be trusted, e.g., by verifying if the public key of the issuer is known and trusted or it is in a trusted registry, or a trusted party has issued a VC for the VC issuer. More details on validation of the digital signature of the issuer may be found in “Verifiable Credentials Data Model v1.1”, W3C Recommendation, W3C, 3 Mar. 2022, https://www.w3.org/TR/2022/REC-vc-data-model-20220303/.

The VP proof comprises at least the following information: a signature type, a timestamp indicating the time the digital signature has been created, purpose of the proof (i.e., authentication), holder public key or public key hash, a challenge (e.g., a nonce), and the digital signature of the holder (i.e., the second TLS device) over messages exchanged between the first TLS device and the second TLS device during the TLS handshake. The first TLS device validates the digital signature of the second TLS device comprised in the VP proof, using the public key of the second TLS device. For example, the first TLS device may calculate a hash of the messages exchanged between the first TLS device and the second TLS device, decrypt the digital signature using the holder public key, and comparing the two hash values. More details on validation of the digital signature of the holder can be found in “Verifiable Credentials Data Model v1.1”, W3C Recommendation, W3C, 3 Mar. 2022, https://www.w3.org/TR/2022/REC-vc-data-model-20220303/.

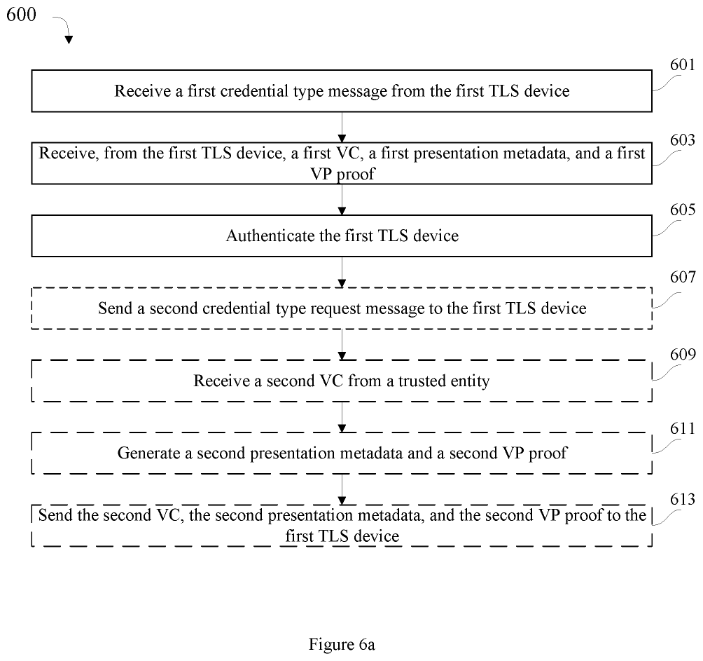

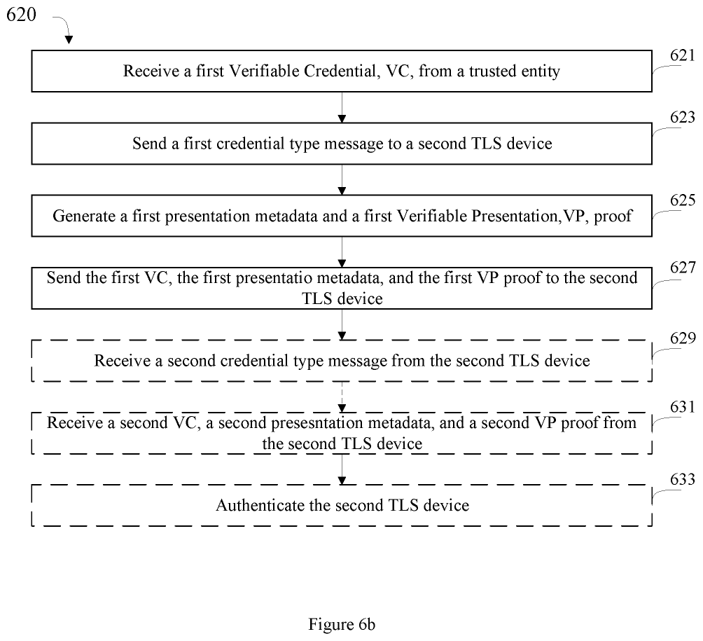

FIG. 6a shows embodiments of a method 600 for supporting authentication of a first TLS device 303. Embodiments of the method may be performed by a second TLS device 305.

Referring to FIG. 6a, in step 601, the method 600 comprises receiving 601, 313 a first credential type indication message from the first TLS device 303. The first credential type indication message is indicative of a credential type to be used for authenticating the first TLS device 303, and the credential type is a VC. More than one credential type may be indicated in the first credential type indication message.

The method 600 further comprises receiving 603, 317, from the first TLS device 303, a first VC, a first presentation metadata, and a first VP proof for verifying the first TLS device 303. The first VC, the first presentation metadata, and the first VP proof may be received in a same message. Alternatively, the first VC, the first presentation metadata, and the first VP proof are received in separate messages. For example, the first VC and the first presentation metadata may be sent in a “Certificate” message and the first VP proof may be sent in a “Certificate Verify” message of the TLS handshake protocol according to RFC 8446.

The method 600 further comprises authenticating 605, 319 the first TLS device 303 using the first VC, the first presentation metadata, and the first VP proof.

Optionally, the first VP proof may comprise a first signature. The first signature may be generated based on at least the first credential type indication message, the first VC, and the first VP proof. The first signature may be generated further based on one or more additional messages received by the first TLS device 303 from the second TLS device 305 and/or sent by the first TLS device 303 to the second TLS device 305.

According to an embodiment of the invention, the first VC comprises an assertion on the first TLS device 303, a first credential metadata, and a first VC proof for verifying a trusted entity which issued the first VC.

The method 600 further comprises sending 607, 325 a second credential type indication message to the first TLS device 303. The second credential type indication message comprises an indication of a credential type to use for authenticating the second TLS device 305. According to an embodiment, more than one credential type may be indicated in the second credential type indication message. The credential type may be VC, X.509, or any other supported credential type, such as OpenPGP, Raw Public Key, or 1609Dot2. If the first TLS device 303 is a TLS client and the second TLS device 305 is a TLS server, the second TLS device 305 sends 607 the second credential type indication message to the first TLS device 303 in response to a message received from the first TLS device 303 indicating the credential types that the first TLS device 303 supports. The message sent by the first TLS device to the second TLS device indicating the credential types that the first TLS device supports may be a “ClientHello” message with a “server_certificate_type” extension field and the second credential type indication sent by the second TLS device to the first TLS device may be a “ServerHello” message with the “server_certificate_type” extension field. If the first TLS device 303 is a TLS server and the second TLS device 305 is a TLS client, the second TLS device 305 may send 607 the second credential type indication message to the first TLS device 303 in a “ClientHello” message with a “client_certificate_type” extension field.

The method 600 further comprises, if the credential type of certificate is VC, receiving 609, 323 a second VC from a trusted entity. In step 611, the method 600 further comprises generating 611, 327 a second presentation metadata, and a second VP proof for verifying the second TLS device 305. The method 600 further comprises sending 613, 329 the second VC, the second presentation metadata, and the second VP proof to the first TLS device 303.

According to an embodiment of the invention, the second VC comprises an assertion on the second TLS device 305, a second credential metadata, and a second VC proof for verifying the trusted entity which issued the second VC. The second VP proof comprises a second signature. The second signature is generated based on at least the second VC, the second presentation metadata, the second VP proof, and the second credential type indication message. The second signature may be generated further based on one or more additional messages received by the second TLS device 305 from the first TLS device 303 and/or sent by the second TLS device 305 to the first TLS device 303.

According to an embodiment of the invention, the first TLS device 303 is one of a TLS client and a TLS server, and the second TLS device 305 is the other one of the TLS client and the TLS server. It will be appreciated that the method 600 may comprise additional, alternative, or modified, steps in accordance with what is described throughout this disclosure. An embodiment of the method 600 may be implemented as a computer program 704 comprising instructions which, when the computer program 704 is executed by the second TLS device 305, cause the second TLS device 305 to carry out the method 600 and become operative in accordance with embodiments of the invention described herein. The computer program 704 may be stored in a computer-readable data carrier, such as the memory 702. Alternatively, the computer program 704 may be carried by a data carrier signal, e.g., downloaded to the memory 702 via a network interface circuitry 703.

FIG. 6b shows embodiments of a method 620 for supporting authentication of a first TLS, device. The method may be performed by a first TLS device 303.

Referring to the method 620 of FIG. 6b, the method comprises receiving 621, 311 a first VC from a trusted entity.

The method 620 further comprises sending 620, 313 a first credential type indication message to a second TLS device 305. The first credential type indication message comprises an indication of a credential type to use for authenticating the first TLS device 303. The credential type is VC. More than one credential type may be indicated in the first credential type indication message.

The method 620 further comprises generating 625, 315 a first presentation metadata, a first VP proof. The method 620 further comprises sending 627 the first VC and the first VP proof to the second TLS device 305.

According to an embodiment of the invention, the first VC, the first presentation metadata, and the first VP proof are sent in a same message. According to an alternative embodiment of the invention, the first VC, the first presentation metadata, and the first VP proof are sent in separate messages. For example, the first VC and the first presentation metadata may be sent in a “Certificate” message and the first VP proof may be sent in a “Certificate Verify” message of the TLS handshake protocol according to RFC 8446.

According to an embodiment of the invention, the first VP proof comprises a first signature. The first signature is generated based on at least the first credential type indication message, the first VC, the first presentation metadata, and the first VP proof. The first signature may be generated further based on one or more additional messages received by the second TLS device 305 from the first TLS device 303 and/or sent by the second TLS device 305 to the first TLS device 303.

According to an embodiment of the invention, the first VC comprises an assertion on the first TLS device 303, a first credential metadata, and a first VC proof for verifying the trusted entity which issued the first VC.

The method 620 further comprises receiving 629, 325 a second credential type indication message from the second TLS device 305. The second credential type indication message comprises an indication of a credential type to be used for authenticating the second TLS device 305. According to an embodiment of the invention, the credential type is VC. According to an alternative embodiment of the invention, the credential type is X.509. According to an embodiment, more than one credential type may be indicated in the second credential type indication message. The credential type may also be any other supported certificate type such as OpenPGP, Raw Public Key, or 1609Dot2 .

The method 620 further comprises receiving 631, 329 a second VC, a second presentation metadata, and a second VP proof from the second TLS device 305. The method 620 further comprises authenticating 633, 331 the second TLS device 305 using the second VC, the second presentation metadata, and the second VP proof.

According to an embodiment of the invention, the second VC comprises an assertion on the second TLS device 305, a second credential metadata, and a second VC proof for verifying a trusted entity which issued the second VC. The second VP proof comprises a second signature. The second signature is generated based on at least the second VC, the second presentation metadata, the second VP proof, and the second credential type identification message. The second signature may be generated further based on one or additional messages received by the first TLS device 303 from the second TLS device 305 and/or sent by the first TLS device 303 to the second TLS device 305.

According to an embodiment of the invention, the first TLS device 303 is one of a TLS client and a TLS server, and the second TLS device 305 is the other one of the TLS client and the TLS server.

It will be appreciated that the method 620 may comprise additional, alternative, or modified, steps in accordance with what is described throughout this disclosure. An embodiment of the method 620 may be implemented as a computer program 904 comprising instructions which, when the computer program 904 is executed by the first TLS device 303, cause the first TLS device 303 to carry out the method 620 and become operative in accordance with embodiments of the invention described herein. The computer program 904 may be stored in a computer-readable data carrier, such as the memory 902. Alternatively, the computer program 904 may be carried by a data carrier signal, e.g., downloaded to the memory 902 via a network interface circuitry 903.

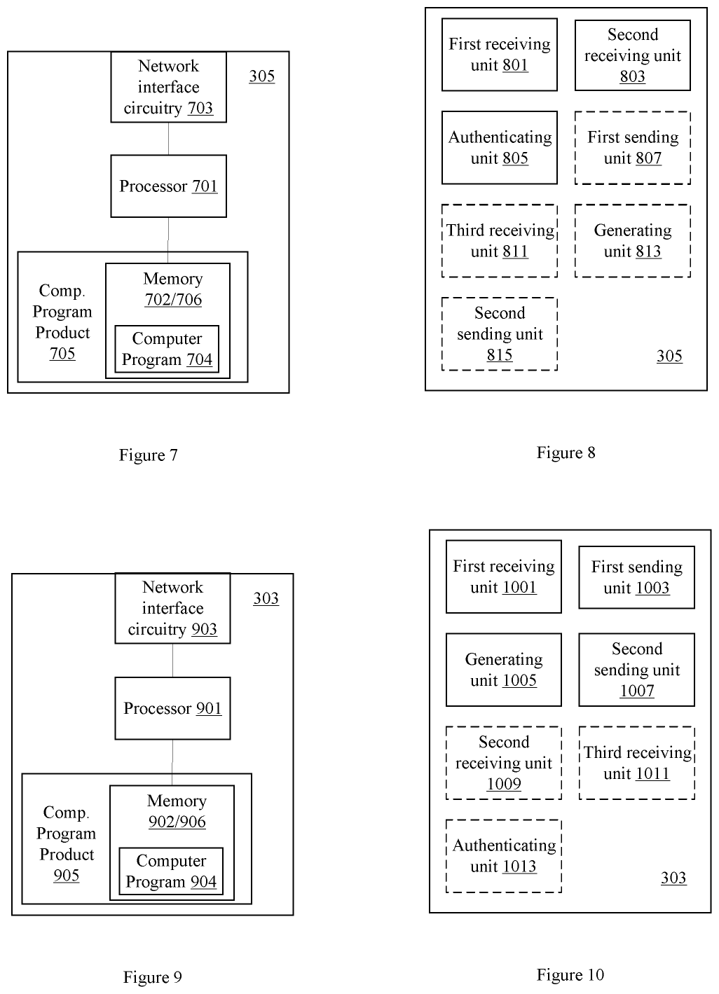

FIG. 7 is a block diagram illustrating an embodiment of the second TLS device 305, comprising a processor circuitry 701, a computer program product 705 in the form of a computer readable storage medium 706, such as a memory 702, and the network interface circuitry 703.

The processing circuitry 701 may comprise one or more processors, such as Central Processing Units (CPUs), microprocessors, application processors, application-specific processors, Graphics Processing Units (GPUs), and Digital Signal Processors (DSPs) including image processors, or a combination thereof, and the memory 702 comprising a computer program 705 comprising instructions. When executed by the processor(s) 701, the instructions cause the second TLS device 305 to become operative in accordance with embodiments of the invention described herein, in particular with reference to FIG. 6a. The memory 702 may include a Read-Only-Memory (ROM), e.g., a flash ROM, a Random-Access Memory (RAM), e.g., a Dynamic RAM, DRAM, or Static RAM, SRAM, a mass storage, e.g., a hard disk or solid-state disk, or the like. The computer program 705 may be downloaded to the memory 702 by means of the network interface circuitry 703, as a data carrier signal carrying the computer program 705. The network interface circuitry may comprise one or more of a cellular modem (e.g., GSM, UMTS, LTE, 5G, or higher generation), a WLAN/Wi-Fi modem, a Bluetooth modem, an Ethernet interface, an optical interface, or the like, for exchanging data between the second TLS device 305 and the first TLS device 303, other computing devices, communications devices, a radio-access network, and/or the Internet. The processing circuitry 701 may alternatively or additionally comprise one or more Application-Specific Integrated Circuits (ASICs), Field-Programmable Gate Arrays (FPGAs), or the like, which are operative to cause the second TLS device 305 to become operative in accordance with embodiments of the invention described herein.

The second TLS device 305 may be a sensor, a Machine Type Communication (MTC) device, a Machine-to-Machine (M2M) device, an Internet of Things (IoT) device, a user device, a vehicle, a router, a gateway, or any computing device with network connectivity implementing a TLS client or a TLS server. The TLS client or TLS server may be implemented for example as a Virtual Machine or a container.

FIG. 8 schematically illustrates, in terms of functional units, the components of a second TLS device 305 according to an embodiment of the invention. The second TLS device 305 comprises a first receiving unit 801 configured to receive a first credential type indication message from the first TLS device, wherein the first credential type indication message is indicative of a credential type to be used for authenticating the first TLS device, wherein the credential type is VC. The second TLS device 305 further comprises a second receiving unit 803 configured to receive, from the first TLS device, a first VC and a first VP proof for verifying the first TLS device. The second TLS device 305 further comprises an authenticating unit 805 configured to use the first VC and the first VP proof received by the second receiving unit 803 to authenticate the first TLS device.

Then the second TLS device 305 may optionally further comprise: a first sending unit 807 configured to send a second credential type indication message to the first TLS device, wherein the second credential type indication message comprises an indication of a credential type to be used for authenticating the second TLS device. The second TLS device 305 may further comprise a third receiving unit 811 configured to receive a second VC from a trusted entity. The second TLS device 305 may further comprise a generating unit 813 configured to generate a second VP proof for verifying the second TLS device. The second TLS device 305 may further comprise a second sending unit 815 configured to send to the first TLS device the second VC and the second VP proof generated by the generating unit 813.

FIG. 9 is a block diagram illustrating one embodiment of a first TLS device 303 comprising a processor circuitry 901, a computer program product 905 in the form of a computer readable storage medium 906 in the form of a memory 902 and the network interface circuitry 903.

The processing circuitry 901 may comprise one or more processors 901, such as CPUs, microprocessors, application processors, application-specific processors, GPUs, and DSPs including image processors, or a combination thereof, and the memory 902 comprising a computer program 905 comprising instructions. When executed by the processor(s) 901, the instructions cause the first TLS device 303 to become operative in accordance with embodiments of the invention described herein, in particular with reference to FIG. 6b. The memory 902 may include a ROM, e.g., a flash ROM, a RAM, e.g., a Dynamic RAM, DRAM, or Static RAM, SRAM, a mass storage, e.g., a hard disk or solid-state disk, or the like. The computer program 905 may be downloaded to the memory 902 by means of the network interface circuitry 903, as a data carrier signal carrying the computer program 905. The network interface circuitry may comprise one or more of a cellular modem (e.g., GSM, UMTS, LTE, 5G, or higher generation), a WLAN/Wi-Fi modem, a Bluetooth modem, an Ethernet interface, an optical interface, or the like, for exchanging data between the first TLS device 303 and the second TLS device 305, other computing devices, communications devices, a radio-access network, and/or the Internet. The processing circuitry 901 may alternatively or additionally comprise one or more ASICs, FPGAs, or the like, which are operative to cause the first TLS device 303 to become operative in accordance with embodiments of the invention described herein.

The first TLS device 303 may be, a sensor, an MTC device, an M2M, an IoT device, a user device, a vehicle, a router, a gateway, or any computing device with network connectivity implementing a TLS client or a TLS server, wherein the TLS client or TLS server are implemented as a Virtual Machine or a container.

FIG. 10 schematically illustrates, in terms of functional units, the components of a first TSL device 303 according to an embodiment of the invention. The first TLS device 303 comprises a first receiving unit 1001 configured to receive a first VC from a trusted entity. The first TLS device 303 further comprises a first sending unit 1003 configured to send a first credential type indication message to a second TLS device, wherein the first credential type indication message comprises an indication of a credential type to use for authenticating the first TLS device, wherein the credential type is VC. The first TLS device 303 further comprises a generating unit 1005 configured to generate a first VP proof. The first TLS device 401 further comprises a second sending unit 1007 configured to send the first VC and the first VP proof to the second TLS device.

The first TLS device 303 may optionally further comprise: a second receiving unit 1009 configured to receive a second credential type indication message from the second TLS device, wherein the second credential type indication message comprises an indication of a credential type to use for authenticating the second TLS device. The first TLS device 303 may further comprise a third receiving unit 1011 configured to receive a second VC and a second VP proof from the second TLS device. The first TLS device 303 may further comprise an authenticating unit 1013 configured to authenticate the second TLS device using the second VC and the second VP proof.

1-70. (canceled)

71. A method for supporting authentication of a first Transport Layer Security (TLS) device, the method being performed by a second TLS device and comprising:
receiving a first credential type indication message from the first TLS device, wherein the first credential type indication message is indicative of a credential type to use for authenticating the first TLS device, and wherein the credential type is Verifiable Credential (VC);
receiving, from the first TLS device, a first VC, first presentation metadata, and a first Verifiable Presentation (VP) proof for verifying the first TLS device; and
authenticating the first TLS device using the first VC, the first presentation metadata, and the first VP proof.

72. The method according to claim 71, wherein the first VP proof comprises a first signature.

73. The method according to claim 72, wherein the first signature is generated based on at least the first credential type indication message, the first VC, the first presentation metadata, and the first VP proof.

74. The method according to claim 73, wherein the first signature is generated further based on one or more additional messages received by the first TLS device from the second TLS device and/or sent by the first TLS device to the second TLS device.

75. The method according to claim 71, wherein the second TLS device is authenticated by the first TLS device with the credential type X.509.

76. A method for supporting authentication of a first Transport Layer Security (TLS) device, the method being performed by the first TLS device and comprising:
receiving a first Verifiable Credential (VC) from a trusted entity;
sending a first credential type indication message to a second TLS device, wherein the first credential type indication message comprises an indication of a credential type to use for authenticating the first TLS device, wherein the credential type is Verifiable Credential (VC);
generating first presentation metadata and a first VP proof; and
sending the first VC, the first presentation metadata, and the first VP proof to the second TLS device.

77. A second Transport Layer Security (TLS) device for supporting authentication of a first TLS device, the second TLS device comprising a processing circuitry causing the second TLS device to be operative to:
receive a first credential type indication message from the first TLS device, wherein the first credential type indication message comprises an indication of a credential type to use for authenticating the first TLS device, wherein the credential type is Verifiable Credential (VC);
receive, from the first TLS device, a first VC, first presentation metadata, and a first Verifiable Presentation (VP) proof for verifying the first TLS device; and
authenticate the first TLS device using the first VC, the first presentation metadata, and the first VP proof.

78. The second TLS device according to claim 77, wherein the first signature is generated further based on one or more additional messages received by the first TLS device from the second TLS device and/or sent by the first TLS device to the second TLS device.

79. The second TLS device according to claim 77, wherein the processing circuitry causes the second TLS device to be operative to:
send a second credential type indication message to the first TLS device, wherein the second credential type request message comprises an indication of a credential type to use for authenticating the second TLS device.

80. The second TLS device according to any one of claims 77, wherein the processing circuitry causes the second TLS device to be operative to:
receive a second VC from a trusted entity;
generate a second VP proof for verifying the second TLS device and a second presentation metadata; and
send the second VC, the second presentation metadata, and the second VP proof to the first TLS device.

81. The second TLS device according to claim 80, wherein the second VC comprises an assertion on the second TLS device, a second credential metadata, and a second VC proof for verifying the trusted entity which issued the second VC.

82. The second TLS device according to claim 80, wherein the second VP proof comprises a second signature.

83. The second TLS device according to claim 82, wherein the second signature is generated based on at least the second VC, the second presentation metadata, the second VP proof, and the second credential type indication message.

84. The second TLS device according to claim 83, wherein the second signature is generated further based on one or more additional messages received by the second TLS device from the first TLS device and/or sent by the second TLS device to the first TLS device.

85. The second TLS device according to claim 77, wherein the second TLS device is authenticated by the first TLS device with the credential type X.509.

86. A first Transport Layer Security (TLS) device for supporting authentication of the first TLS device, the first TLS device comprising a processing circuitry causing the first TLS device to be operative to:
receive a first Verifiable Credential (VC) from a trusted entity;
send a first credential type request message to a second TLS device, wherein the first credential type indication message comprises an indication of a credential type to use for authenticating the first TLS device, wherein the credential type is a VC;
generate first presentation metadata and a first Verifiable Presentation (VP) proof; and
send the first VC, the first presentation metadata, and the first VP proof to the second TLS device.

87. The first TLS device according to claim 86, wherein the first TLS device sends the first VC, the first presentation metadata, and the first VP proof in a same message.

88. The first TLS device according to claim 86, wherein the first TLS device sends the first VC, the first presentation metadata, and the first VP proof in separate messages.

89. The first TLS device according to claim 86, wherein the first VP proof comprises a first signature.

90. The first TLS device according to claim 86, wherein the first VC comprises an assertion on the second TLS device, a first credential metadata, and a first VC proof for verifying the trusted entity which issued the first VC.
